(19) United States
(12) Patent Application Publication
(10) Pub. No.: US 2015/0356469 A1
(43) Pub. Date: Dec. 10, 2015

(54) SYSTEM AND METHOD FOR MANAGEMENT PARKING SPACES

(71) Applicant: Ying-Tsun SU, (US)

(72) Inventor: Ying-Tsun SU, Taipei City (TW)

(21) Appl. No.: 14/759,904

(22) PCT Filed: Jan. 23, 2013
(86) PCT No.: PCT/CN2013/070859

§ 371 Date: Jul. 8, 2015

(51) Int. Cl. G06Q 10/02; G06Q 40/08

(52) U.S. Cl. CPC G06Q 10/02; G06Q 40/08; G06Q 2240/00

(57) ABSTRACT

A system and method for managing parking spaces perform the following steps. Receive a login message corresponding to a first vehicle, a reservation message, and an insurance message from a client end. The reservation message indicates a reserved parking space among the parking spaces, and the insurance message indicates an insurance period and an insurance coverage. Determine whether the first vehicle parking in the reserved parking space matches the insurance coverage when the insurance period is expired. Make an insurance expiration record corresponding to the insurance message when the first vehicle parking in the reserved parking space matches the insurance coverage.

### CROSS-REFERENCE TO RELATED APPLICATIONS

This non-provisional application claims priority under 35 U.S.C. §119(a) on Patent Application No(s). PCT/CN2013/070859 filed in China on 2013 Jan. 23, 2012, the entire contents of which are hereby incorporated by reference.

### TECHNICAL FIELD

The disclosure relates to a management system and a management method, more particularly to a system and method of managing parking spaces.

### BACKGROUND

The continuous increase of the quantity of vehicles in every country with economic development has resulted in a greater increase of demand for parking spaces, so that the management of parking spaces has become very important. Parking lots nowadays do not provide any safekeeping service, so that vehicle owners have to cover losses by themselves when their vehicles are damaged or stolen in such parking lots. Even if the vehicle owner installs an anti-theft device on the vehicle, it is hard to prevent the vehicle from being stolen by a car thief. Moreover, it is impossible for a vehicle owner to submit claims for damages, such as collision, scratch or malicious graffiti, caused when the vehicle is in the parking lot, to the organization of the parking lot.

Moreover, until now most parking lots only show the number of vacant parking spaces at the entrance of the parking lot but are incapable of providing drivers with more information that is more immediate. Once a parking lot has a high number of vehicles, and even does not provide drivers with the real-time number of vacant parking spaces, a driver who is seeking an available parking space needs to spend a lot of time on inefficiently-searching for one.

### SUMMARY

According to one or more embodiments, the disclosure provides a management method for managing parking spaces. In one embodiment, the management method includes the following steps. Receive a login message corresponding to a first vehicle from a client end. Receive a reservation message and an insurance message from the client end. The reservation message indicates a reserved parking space among the plurality of parking spaces, and the insurance message indicates an insurance period and an insurance coverage. Determine whether the first vehicle parking in the reserved parking space matches the insurance coverage when the insurance period is expired. Make an insurance expiration record corresponding to the insurance message when the first vehicle parking in the reserved parking space matches the insurance coverage.

According to one or more embodiments, the disclosure provides a management system for managing parking spaces. In one embodiment, the management system includes a plurality of sensors and a management device. The sensors are respectively disposed in the parking spaces and determine whether the parking spaces are occupied. The management device is connected to the sensors. The management device receives a login message corresponding to a first vehicle from a client end. The management device receives a reservation message and an insurance message from the client end. The reservation message indicates a reserved parking space among the parking spaces, and the insurance message indicates an insurance period and an insurance coverage. When the insurance period is expired, the management device determines whether the first vehicle parking in the reserved parking space matches the insurance coverage. When the first vehicle parking in the reserved parking space matches the insurance coverage, the management device makes an insurance expiration record corresponding to the insurance message.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a schematic view of a management system of parking spaces according to an embodiment of the disclosure;

FIG. 2 is a flow chart of a management method of parking spaces according to an embodiment of the disclosure;

FIG. 3 is a schematic view of a user interface according to an embodiment of the disclosure;

FIG. 4 is a flow chart of a management method of parking spaces according to another embodiment of the disclosure;

FIG. 5 is a schematic view of schematic display block according to an embodiment of the disclosure; and

FIG. 6 is a flow chart of a management method of parking spaces according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

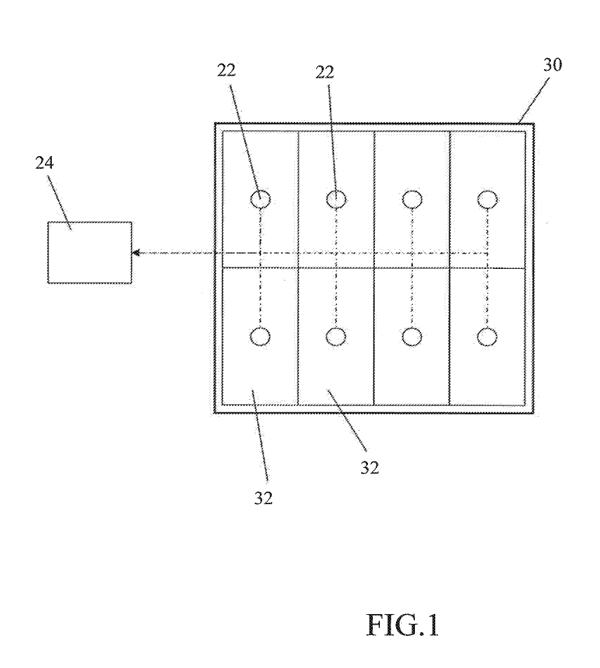

The disclosure provides a management system and a management method to manage a plurality of parking spaces. Please refer to FIG. 1, which is a schematic view of a management system of parking spaces according to an embodiment of the disclosure.

The management system includes a plurality of sensors (also known as detectors) 22 and a management device 24. The sensors 22 can be disposed at a plurality of parking spaces 32 in a parking lot 30. The sensor 22 can be, for example but not limited to, an infrared sensor, a laser sensor, an ultrasonic sensor, a semiconductor sensor or a small camera, which is capable of sensing whether the corresponding parking space 32 is occupied. The semiconductor sensor can be carried out by, for example but not limited to, a photovoltaic cell or a light emitting diode (LED). An infrared sensor as a sensor 22 includes, for example, an infrared emitter and an image receiver, and the infrared emitter and the image receiver are paired and near to each other. The infrared emitter emits infrared light for the image receiver to receive. According to the output of the image receiver in the sensor 22, the management device 24 can determine whether the infrared light emitted by the infrared emitter is blocked or not, to determine the existence of any object in the detection range of the sensor 22. If an object blocks the infrared light emitted by the sensor 22, the management device 24 will consider that the parking space 32 corresponding to the sensor 22 is occupied.

In an embodiment, one sensor 22 can be disposed at one parking space 32. In another embodiment, more than one sensor 22 can be disposed at different locations in a single parking space 32. If some of the sensors 22 disposed in the single parking space 32 sense the existence of an object, the management device 24 may consider that the parking space 32 is occupied by an object with a great area, to confirm that a vehicle is parked in the parking space 32.

The management device 24 is connected to the sensors 22 and performs the management method. The management device 24 is wiredly or wirelessly connected to the sensors 22 and reads the outputs of the sensors 22. For example, the sensor 22 can transmit data to the management device 24 through, for example but not limited to, bluetooth, ZigBee, code-division multiple access (CDMA), global system for mobile communications (GSM), general packet radio service (GPRS), WiMAX or WiFi. The sensors 22 and the management device 24 include a communication module to access data.

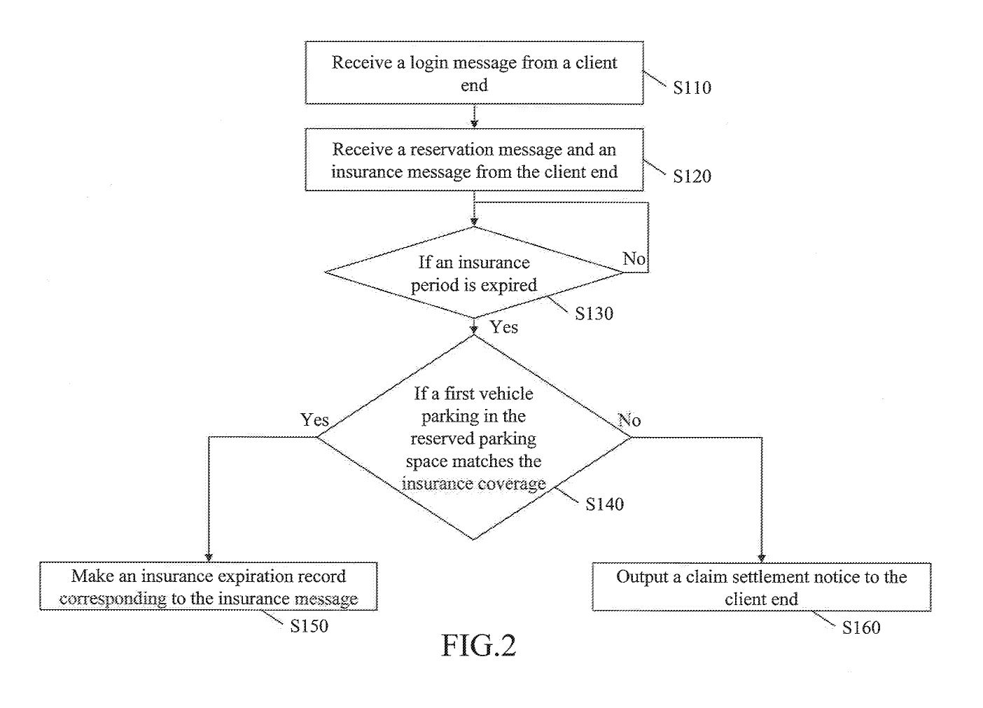

The operation of the management system is illustrated by referring to FIG. 2, which is a flow chat of a management method of parking spaces according to an embodiment of the disclosure.

As shown in step S110, the management device 24 wiredly or wirelessly receives a login message from a client end that is, for example but not limited to, a mobile phone, a notebook, a tablet computer, a vehicle navigation system or a desk-top computer. A user can link to the management device 24 and send the login message to the management device 24 through applications or browsers executed on the client end. The management device 24 provides a graphical user interface (GUI) for the user to register, log in or reserve any services supported by the management system.

Before login, the user has to register an account for accessing the service provided by the management system. Then, this account is stored in the management device 24. The account corresponds to at least a first vehicle. The management device 24 manages some information about every registered account, which relates to a plate number of the first vehicle, a user's mobile-phone number and/or a card number of a credit card. When one account corresponds to a single first vehicle, the management device 24 automatically knows the first vehicle corresponding to the login message because of the user's login.

After logging in the management system, the user can reserve a parking space 32 and also purchase a parking insurance. Then, the management device 24 receives a reservation message and an insurance message from the client end (step S120). The reservation message indicates a reserved parking space that is one of the parking spaces 32 in the parking lot 30. The user can use the GUI to select and reserve a desired parking space 32 as a reserved parking space or can assign the management system to automatically choose one of the available parking spaces 32.

The insurance message recites, for example but not limited to, an insurance period and one or more insurance coverages the user defines. In an embodiment, the insurance period is automatically set as how long the user attempts to use the parking space 32. In another embodiment, the user can manually set a reservation period that is longer than the insurance period. For instance, the reservation period is from 5 o'clock in the evening till 8 o'clock the next morning while the insurance period is from 11 o'clock that evening till 5 o'clock the next morning. The following embodiments are illustrated based on an insurance period equal to a reservation period in order to concisely describe the operation of the management system.

The insurance coverages include, for example but not limited to, vehicle loss (theft), auto-part loss (theft), vehicle body damage, or water damage. For example, the insurance for auto-part loss can insure against the loss of audio equipment or tires. Vehicle body damage and vehicle body destruction are classified as scratches to the car paint or a collision with another vehicle. Vehicle body destruction means more serious vehicle body damage.

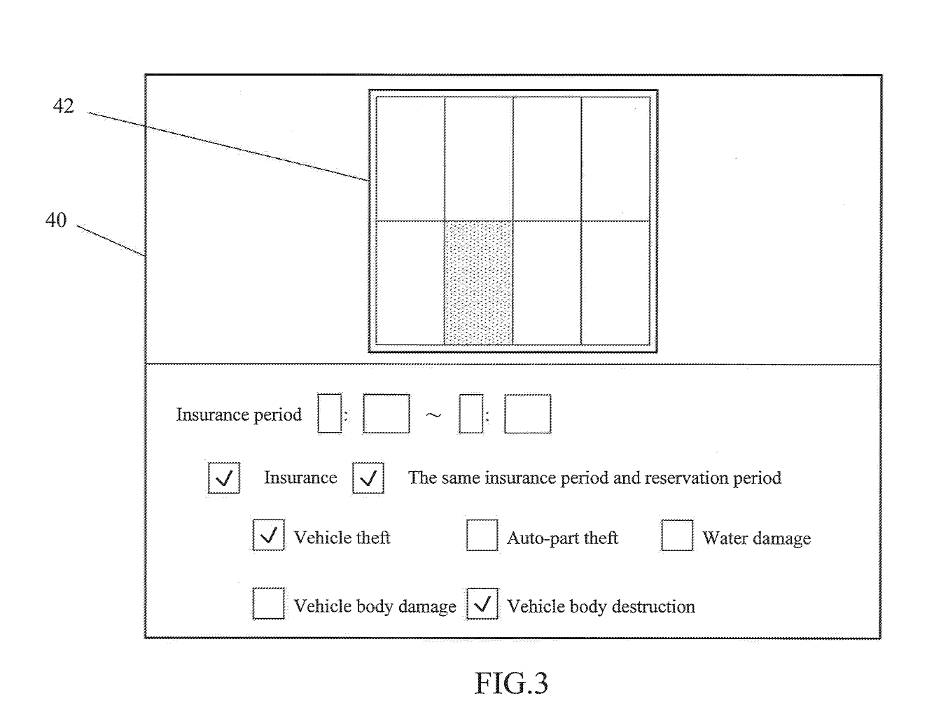

On the other hand, the disclosure has no limitation on the user interface the management system provides to users. In an embodiment, a user interface is illustrated by referring to FIG. 3, which is a schematic view of a user interface 40. The user interface 40 includes a schematic graphic display block 42 for displaying a schematic graphic that shows locations of the parking spaces 32. The user can select one parking space 32 as a reserved parking space in the schematic graphic display block 42, input a reservation period and an insurance period, and select one or more desired insurance coverages. The schematic display block 42 shows the whole or a part of the parking spaces 32 in the parking lot 30. The parking spaces 32 are, for example but not limited to, roadside parking spaces, so the schematic display block 42 shows the whole or partial schematic graphic of a road and shows these parking spaces 32 along the roadside.

Therefore, the user can park the first vehicle in the reserved parking space during the reservation period until the reservation period is expired.

To know the state of parking insurance, the management device 24 regularly determines whether the insurance period is expired (S130). When the insurance period is expired, the management device 24 further determines whether the first vehicle parking in the reserved parking space matches any insurance coverage the user has insured (step S140).

In an exemplary embodiment, the user is insured for vehicle loss. The management device 24, through one or more sensors 22 disposed in the reserved parking space, keeps determining whether the first vehicle leaves the reserved parking space, to know if the first vehicle is stolen. With regard to other insurance coverages such as vehicle body damage or vehicle body destruction, the guard of the parking lot 30 may determine if the first vehicle is damaged or destroyed, and report the determination result to the management system by themselves.

When the first vehicle parking in the reserved parking space matches the insurance coverage (that is, the insurance coverage required by the user has been insured), the management device 24 makes an insurance expiration record corresponding to the insurance message (step S150). When the first vehicle parking in the reserved parking space does not match the insurance coverage, the management device 24 outputs a claim settlement notice to the client end (step S160).

In an embodiment, when the first vehicle leaves the reserved parking space during the insurance period, the management device 24 outputs a vehicle loss notice to the client end. In addition to the claim settlement notice, the management device 24 also makes a claim settlement record that recites, for example but not limited to, the reservation message, the insurance message, and the information indicating if the first vehicle matches the insurance coverage. Therefore, the claim settlement record will be used as a reference for settling claims.

In an embodiment, when the reservation period has not been expired and the user attempts to drive out from the reserved parking space, the user can use the client end to send a departure message to the management device 24 before driving out from the reserved parking space. Therefore, the management device 24 may not misunderstand what the user is doing and consider what the user is doing as vehicle theft. In another embodiment, when sensing that the first vehicle is been driving away from the reserved parking space, the management device 24 can output a confirmation inquiry for the user to respond with a confirmation message indicating that the user confirms the driver is himself.

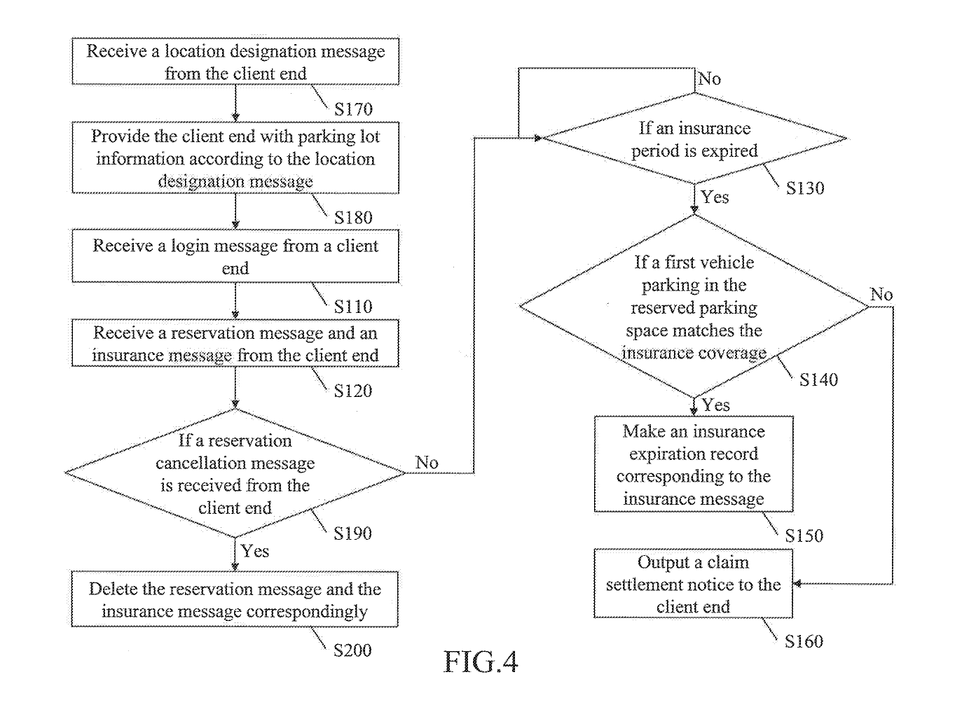

On the other hand, the user can use the GUI provided by the management system to output a location designation message for searching for a parking space 32 in a certain region of the parking lot 30. The detailed searching process is illustrated as follows by referring to FIG. 4, which is a flow chart of a management method of parking spaces according to another embodiment of the disclosure.

The management device 24 receives a location designation message from the client end (step S170) and provides parking lot information to the client end according to the location designation message, (step S180). In some embodiments, step S170 and step S180 are performed after step S110 is performed.

The location designation message includes, for example but not limited to, a road name, a street name, a house number, a building name or a landmark name. The parking lot information includes, for example but not limited to, the parking space information of each parking space 32. The parking space information includes, for example but not limited to, a position, size or type of a parking space, an organization name, an available reservation period, charging information, statistical demand information, statistical loss information, or statistical damage information.

The size of the parking space is an area of the parking space 32 in an embodiment, and in another embodiment, is classified into a large size, a middle size or a small size according to multiple area thresholds. Moreover, a different size of the parking space corresponds to a different first vehicle. For example, a tour bus or a truck can park in a large parking space 32, and a motorcycle can park in a small parking space 32. The types of parking spaces include, for example but not limited to, a plane type and a mechanical type.

The organization name is a name of an organization that the parking lot 30 belongs to, such as Apple Store SoHo or Taipei City Government. The available reservation period indicates a time period that the parking space 32 has not been reserved for during a day. For example, the available reservation period is, for example but not limited to, 2012 Dec. 4 09:00-20:59. The charging information in an embodiment includes information about a different rental of the parking space 32 at a different time period and/or if the parking space 32 is free, and in another embodiment, further indicates a parking fee and an insurance fee.

In an embodiment, the management device 24 collects all reservation records, insurance records, vehicle loss records or vehicle body damage records up to the current time and analyzes them to obtain statistics on the demand for parking spaces or the loss or damage to vehicles. For example, the management device 24 can count how many total hours a parking space 32 is occupied during a day, and then divides the number of hours by 24 (i.e. 24 hours) to obtain a division result that indicates a demand state, i.e. how popular the parking space 32 is. Moreover, the management device 24 may have one or more demand thresholds to define different demand levels, such as a high demand, a middle demand, and a low demand. Similarly, the management device 24 may also analyze the vehicle loss records or the vehicle body damage records to obtain the statistics on the vehicle loss or damage of each parking space and provides the statistical result to users for their reference.

In an embodiment, the management device 24 processes or displays such statistics according to different time slices. For example, the statistic on the demand of a parking space 32 from 11:00 PM to 5:00 AM indicates a high demand, and the statistic on the demand of this parking space 32 from 1:00 PM to 5:00 PM indicates a low demand.

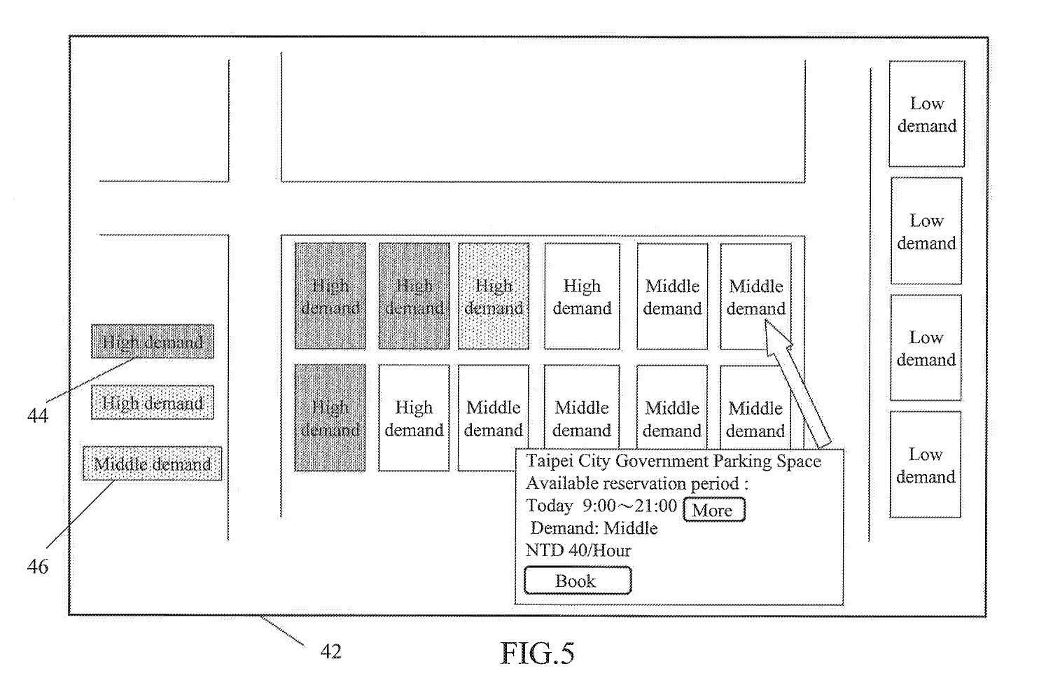

Please refer to FIG. 5, which is a schematic view of a schematic display block 42 according to an embodiment of the disclosure. The schematic display block 42 displays a map presenting an ambient environment of a road name, a street name, a house number, a building name or a landmark name recited in the location designation message, and the map also shows such parking space information. For example, the management device 24 can show the occupied parking space 44 and the reserved parking space 46 so that users can know which parking space 32 is available.

The icon of each parking space 32 in FIG. 5 can provide a part of the parking space information. When a user points a cursor to the icon of a parking space 32 or touches the icon, the system may provide the user with the detailed parking space information of this parking space 32 and may also provide a relative reservation button.

On the other hand, the parking spaces 32 in an embodiment are roadside parking spaces so that these parking spaces 32 are considered as a parking lot 30 belonging to a certain organization. For example, a parking space at the roadside of Section 5, Zhongxiao East Road, Taipei City belonging to Taipei City Government, so that this parking space is considered as one of the parking spaces of one of the parking lots managed by the Taipei City Government.

In an embodiment, after receiving the user's reservation, the management device 24 determines whether a reservation cancellation message corresponding to the received reservation message is received from the client end (step S190). When receiving the reservation cancellation, message from the client end, the management device 24 deletes the corresponding reservation message and insurance message (step S200).

In addition, the management device 24 automatically interacts with the client end in response to different situations.

The user logs into the management system again to inform the management device 24 that he has finished parking the first vehicle in the reserved parking space. Therefore, the management device 24 performs the following insurance process after knowing that the first vehicle has been parked in a correct parking space. Alternately, the guard of the parking lot 30 reports such a parking situation to the management system when looking around the parking lot 30.

When the user and the guard of the parking lot 30 do not inform the management device 24 about such a completion of parking, the management device 24 reminds the user and the guard. For example, if the first vehicle has not been parked in the reserved parking space by the time the insurance period has started for a first period. It means that the user may be late or forgot his reservation. Therefore, the management device 24 outputs a reservation reminder to the client end. The first period is, for example but not limited to, 5 minutes or 10 minutes.

When a second vehicle parks in the reserved parking space before a second period (e.g. 10 or 30 minutes) previous to the insurance period starts, because the reserved parking space is occupied by another user, the management device 24 selects a replacement parking space from the parking spaces 32 and outputs a replacement notice to the client end. The replacement notice informs the user that the reserved parking space is occupied by another vehicle, i.e. the second vehicle, and also informs the user about this replacement parking space. By doing so, the user has no need to log in the system and reserve a parking space again. Moreover, the replacement notice includes, for example but not limited to, the parking space information about the replacement parking space so that the user may understand the replacement parking space in more detail.

In addition, the management device 24 also informs the guard of the parking lot 30 so that the guard can know that the second vehicle parking in the reserved parking space is not the first vehicle under the reservation. The guard then notifies the owner of the second vehicle and provides the owner with a payment slip. Herein, neither the management system nor the guard needs to provide the owner of the second vehicle with any service supported by the insurance message related to the first vehicle.

In an embodiment, to minimize the replacing of the reserved parking space, the management device 24 selects the replacement parking space whose parking space information, such as the position and charging information, is the same as or similar to the parking space information of the reserved parking space.

In an embodiment, the management system also supports a vehicle searching service. When the first vehicle parks in the reserved parking space and the management device 24 receives a vehicle searching message from the client end, the management device 24 provides the position of the reserved parking space to the client end. For example, the management device 24 provides a schematic graphic of the ambient environment of the reserved parking space and marks the position in the schematic graphic, Therefore, even if users forget the positions of their reserved parking spaces or the parking lot 30 is too broad to search for their reserved parking spaces, this service may help them to efficiently find their reserved parking spaces.

In an embodiment, the management system also supports different toll collection methods. Users can prepay the parking fee and the insurance fee by credit card or online before parking their vehicles in the parking lot 30, or can pay these fees by cash or with their prepaid cards before leaving the parking lot 30, or can pay these fees by credit card or online after leaving the parking lot 30.

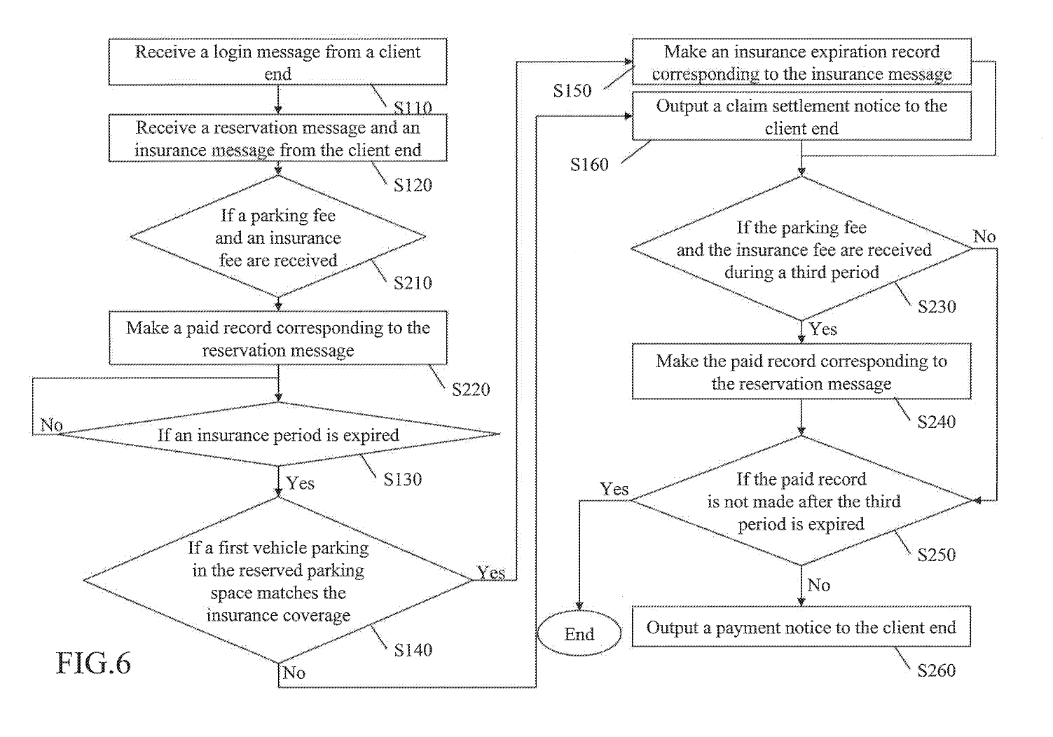

Please refer to FIG. 6, which is a flow chart of a management method of parking spaces according to another embodiment of the disclosure. Before the insurance period is expired, the management device 24 determines whether the parking fee and insurance fee corresponding to the reservation message are received or not (step S210). When the parking fee and the insurance fee are received and the first vehicle does not park longer than its reserved time, the management device makes a paid record corresponding to the reservation message (step S220).

Then, the management device 24 determines whether the parking fee and insurance fee corresponding to the reservation message are received or not during a third period next to the insurance period (step S230). When the parking fee and the insurance fee are received and the first vehicle does not park longer than its reserved time, the management device 24 makes a paid record corresponding to the reservation message (step S240). For example, the third period is 5 minutes or 15 minutes.

Also, the management device 24 determines whether a paid record corresponding to the reservation message is made after the third period next to the insurance period (step S250). When no paid record corresponding to the reservation message is made, the management device 24 outputs a payment notice to the client end (step S260). In addition to the payment notice, the management device 24 also outputs an electronic bill for users to pay on line or by credit cards.

In an embodiment, in steps S210 and S230, the management device 24 may further determine whether the first vehicle parks longer than its reserved time. If yes, the management device 24 calculates the parking fee and the insurance fee according to the reservation period and the overtime period. Similarly, when the first vehicle parks longer than its reserved time, the management device 24 in step S250 calculates the parking fee and the insurance fee according to the reservation period and the overparked period and informs the client end about these fees.

In view of the foregoing embodiments, the management system, by the management method, provides users with various parking space information and allows the users to reserve a parking space. Before logging into the management system, the users can see the schematic graphic of the parking lot and each piece of parking space information shown by the GUI. Therefore, the time spent on searching for a parking space may reduce greatly.

Moreover, the management system provides an insurance service, whereby users can purchase different insurance coverages they need and obtain relative guarantees. On the other hand, the management system may also help the manager of the parking lot to canvass for the parking lot by providing more specific and useful insurance services.

In addition, the management system and the method thereof also support a vehicle searching service and various toll collection methods, whereby users may obtain more friendly and convenient usage experiences.

What is claimed is:

1. A management method of managing a plurality of parking spaces, comprising:
receiving a login message corresponding to a first vehicle from a client end;
receiving a reservation message and an insurance message from the client end, the reservation message indicating a reserved parking space of the plurality of parking spaces, and the insurance message indicating an insurance period and an insurance coverage;
when the insurance period is expired, determining whether the first vehicle parking in the reserved parking space matches the insurance coverage; and
when the first vehicle parking in the reserved parking space matches the insurance coverage, making an insurance expiration record corresponding to the insurance message.

2. The management method according to claim 1, further comprising:
when the first vehicle parking in the reserved parking space does not match the insurance coverage, outputting a claim settlement notice to the client end.

3. The management method according to claim 1, wherein the insurance coverage comprises a vehicle theft, auto-part theft, vehicle body damage, vehicle body destruction or water damage.

4. The management method according to claim 1, further comprising:
receiving a location designation message from the client end; and
providing the client end with a piece of parking lot information according to the location designation message.

5. The management method according to claim 4, wherein the location designation message comprises a road name, a street name, a house number, a building name or a landmark name.

6. The management method according to claim 4, wherein the parking lot information comprises a piece of parking space information about each of the plurality of parking spaces.

7. The management method according to claim 6, wherein the parking space information comprises a position, size or type of a parking space, an organization name, an available reservation period, charging information, statistical demand information, statistical loss information or statistical damage information.

8. The management method according to claim 1, further comprising:
when a reservation cancellation message corresponding to the reservation message is received from the client end, deleting the reservation message and the insurance message correspondingly.

9. The management method according to claim 1, further comprising:
when the first vehicle does not park in the reserved parking space during a first period that starts with the insurance period, outputting a reservation reminder to the client end.

10. The management method according to claim 1, further comprising:
when a second vehicle parks in the reserved parking space before a second period previous to the insurance period starts, selecting a replacement parking space from the plurality of parking spaces and outputting a replacement notice to the client end,
wherein the replacement notice comprises parking space information of the replacement parking space.

11. The management method according to claim 1, further comprising:
when the first vehicle parks in the reserved parking space and a vehicle searching message is received from the client end, providing the client end with a position of the reserved parking space.

12. The management method according to claim 1, further comprising:
when the first vehicle leaves the reserved parking space during the insurance period, outputting a vehicle loss notice to the client end.

13. The management method according to claim 1, further comprising:
when a parking fee and an insurance fee corresponding to the reservation message is received before the insurance period starts, making a paid record corresponding to the reservation message.

14. The management method according to claim 13, further comprising:
when the parking fee and the insurance fee corresponding to the reservation message are received during a third period next to the insurance period, making the paid record corresponding to the reservation message.

15. The management method according to claim 14, further comprising:
when the paid record corresponding to the reservation message is not made after the third period is expired, outputting a payment notice to the client end.

16. A management system for managing a plurality of parking spaces, comprising:
a plurality of sensors respectively disposed in the plurality of parking spaces and configured to detect whether the plurality of parking spaces is occupied; and
a management device connected to the plurality of sensors and configured to perform the following steps:
receiving a login message corresponding to a first vehicle from a client end;
receiving a reservation message and an insurance message from the client end, the reservation message indicating a reserved parking space of the plurality of parking spaces, and the insurance message indicating an insurance period and an insurance coverage;
when the insurance period is expired, determining whether the first vehicle parking in the reserved parking space matches the insurance coverage; and
when the first vehicle parking in the reserved parking space matches the insurance coverage, making an insurance expiration record corresponding to the insurance message.

17. The management system according to claim 16, wherein when the first vehicle parking in the reserved parking space does not match the insurance coverage, the management device outputs a claim settlement notice to the client end.

18. The management system according to claim 16, wherein the insurance coverage comprises a vehicle theft, auto-part theft, vehicle body damage, vehicle body destruction or water damage.

19. The management system according to claim 16, wherein the management device receives a location designation message from the client end and according to the location designation message, provides the client end with a piece of parking lot information.

20. The management system according to claim 19, wherein the location designation message comprises a road name, a street name, a house number, a building name or a landmark name.

21. The management system according to claim 19, wherein the parking lot information comprises parking space information about each of the plurality of parking spaces.

22. The management system according to claim 21, wherein the parking space information comprises a position, size or type of a parking space, an organization name, an available reservation period, charging information, statistical demand information, statistical loss information or statistical damage information.

23. The management system according to claim 16, wherein when receiving a reservation cancellation message corresponding to the reservation message from the client end, the management device deletes the reservation message and the insurance message correspondingly.

24. The management system according to claim 16, wherein when the first vehicle does not park in the reserved parking space during a first period that starts with the insurance period, the management device outputs a reservation reminder to the client end.

25. The management system according to claim 16, wherein when a second vehicle parks in the reserved parking space before a second period previous to the insurance period starts, the management device selects a replacement parking space from the plurality of parking spaces and outputs a replacement notice to the client end, and the replacement ice comprises parking space information of the replacement parking space.

26. The management system according to claim 16, wherein when the first vehicle parks in the reserved parking space and the management device receives a vehicle searching message from the client end, the management device provides the client end with a position of the reserved parking space.

27. The management system according to claim 16, wherein when the first vehicle leaves the reserved parking space during the insurance period, the management device outputs a vehicle loss notice to the client end.

28. The management system according to claim 16, wherein when the first vehicle does not overpark and a parking fee and an insurance fee corresponding to the reservation message is received before the insurance period starts, the management device makes a paid record corresponding to the reservation message.

29. The management system according to claim 28, wherein when the parking fee and the insurance fee corresponding to the reservation message are received during a third period next to the insurance period and the first vehicle does not overpark, the management device makes the paid record corresponding to the reservation message.

30. The management system according to claim 29, wherein when the paid record corresponding to the reservation message is not made after the third period is expired, the management device outputs a payment notice to the client end.
